(19) United States
(12) Patent Application Publication
(10) Pub. No.: US 2014/0235391 A1
(43) Pub. Date: Aug. 21, 2014

(54) ACCESSORY DRIVE BELT TRANSMISSION SYSTEM FOR AUTOMOBILE AND V-RIBBED BELT USED FOR THE SAME

(71) Applicants: TOYOTA JIDOSHA KABUSHIKI KAISHA, Toyota-shi (JP); BANDO CHEMICAL INDUSTRIES, LTD., Hyogo (JP)

(72) Inventors: Hideaki Kawahara, Hyogo (JP); Takeshi Nishigaki, Hyogo (JP); Hideyuki Kato, Hyogo (JP); Kosuke Sogawa, Toyota-shi (JP); Kazunori Ueno, Toyota-shi (JP); Kenji Yamanari, Kariya-shi (JP); Shin Satsumabayashi, Toyota-shi (JP)

(73) Assignees: TOYOTA JIDOSHA KABUSHIKI KAISHA, Toyota-shi (JP); BANDO CHEMICAL INDUSTRIES, LTD., Hyogo (JP)

(21) Appl. No.: 14/138,582

(22) Filed: Dec. 23, 2013

(30) Foreign Application Priority Data
Feb. 21, 2013 (JP) 2013-032371
Jun. 20, 2013 (JP) 2013-129372

(51) Int. Cl. F02B 67/06; F16G 5/06

(52) U.S. Cl. CPC F02B 67/06; F16G 5/06
USPC 474/148; 474/238

(57) ABSTRACT

When the rotational speed of an engine 11 is equal to or higher than 4000 rpm, the rotational fluctuation ratio of a crank shaft pulley 13 at an outer circumferential surface thereof is sometimes equal to or greater than 6%. Moreover, in the layout in which a V-ribbed belt 20 is wound on a plurality of pulleys 14, 15, at least one of span lengths is equal to or longer than 220 mm. The V-ribbed belt 20 includes a back reinforcement fabric.

### CROSS-REFERENCE TO RELATED APPLICATIONS

This application claims priority to Japanese Patent Application No. 2013-032371 filed on Feb. 21, 2013 and Japanese Patent Application No. 2013-129372 filed on Jun. 20, 2013, the entire disclosure of both of which being incorporated by reference herein.

### BACKGROUND

The present disclosure relates to an accessory drive belt transmission system for an automobile and to a V-ribbed belt used for the accessory drive belt transmission system.

In accessory drive belt transmission systems for automobiles, V-ribbed belts have been typically used as power transmission members.

Japanese Unexamined Patent Publication No. 2010-106898 discloses a V-ribbed belt including an adhesive rubber layer in which a core wire formed of aliphatic polyamide fibers and polyester fibers is embedded, a compressed rubber layer provided on an inner circumferential side of the adhesive rubber layer and formed with three V-shaped ribs arranged in a belt width direction, and a back reinforcement fabric bonded to the outer circumference of the adhesive rubber layer.

In recent years, V-ribbed belts each including a back rubber layer instead of a back reinforcement fabric have been used considering cost reduction (see, e.g., Japanese Unexamined Patent Publication No. 2011-252510).

### SUMMARY

An accessory drive belt transmission system for an automobile according to the present disclosure includes an engine; a crank shaft pulley which is a ribbed pulley provided on a crank shaft of the engine; an accessory drive pulley which is a ribbed pulley; and a V-ribbed belt wound on a plurality of pulleys including the crank shaft pulley and the accessory drive pulley and having three or four V-shaped ribs. A rotational fluctuation ratio of the crank shaft pulley at an outer circumferential surface thereof is sometimes equal to or greater than 6% at an engine rotational speed of equal to or higher than 4000 rpm, and at least one of span lengths is equal to or longer than 220 mm in a layout in which the V-ribbed belt is wound on the plurality of pulleys. The V-ribbed belt includes a V-ribbed belt body made of rubber and formed with the V-shaped ribs on an inner circumferential side thereof, a core wire embedded in the V-ribbed belt body and formed of aliphatic polyamide fibers, and a back reinforcement fabric bonded to an outer circumferential part of the V-ribbed belt body.

A V-ribbed belt of the present disclosure is the V-ribbed belt used for the accessory drive belt transmission system for the automobile.

### BRIEF DESCRIPTION OF THE DRAWINGS

FIG. 1 is a front view illustrating a schematic configuration of an accessory drive belt transmission system for an automobile according to an embodiment of the present disclosure.

FIG. 2 is a perspective view illustrating a V-ribbed belt.

FIG. 3A is a front view illustrating a twist angle test machine, and FIG. 3B is an enlarged view of a main part of the twist angle test machine.

FIG. 4 is a view illustrating a layout of pulleys of a belt running test machine.

FIG. 5 is a graph illustrating a relationship between a twist angle and a pressing load.

### DETAILED DESCRIPTION

An embodiment of the present disclosure will be described in detail below with reference to drawings.

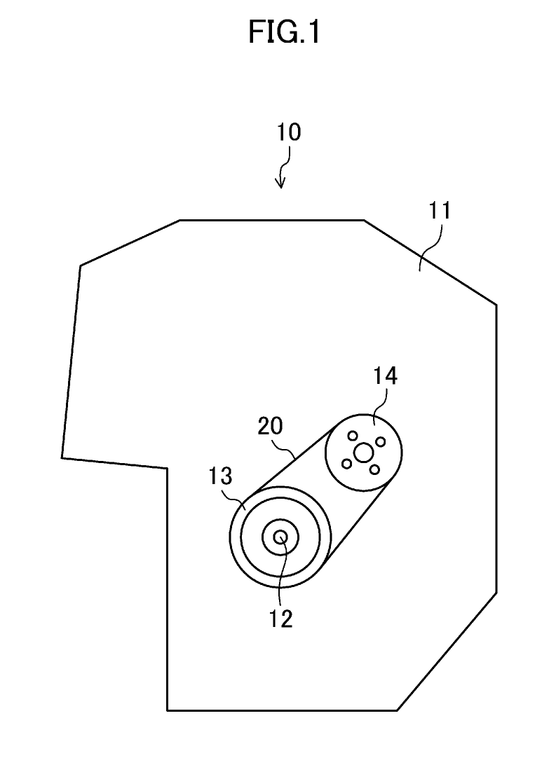

FIG. 1 illustrates an accessory drive belt transmission system 10 for an automobile according to the present embodiment.

The accessory drive belt transmission system 10 of the present embodiment includes an engine 11, a water pump (not shown in the figure) serving as an accessory, a crank shaft pulley 13 serving as a ribbed pulley provided on a crank shaft 12 of the engine 11, a water pump pulley (accessory drive pulley) 14 serving as a ribbed pulley provided on the water pump, and an endless V-ribbed belt 20 wound on the crank shaft pulley 13 and the water pump pulley 14.

The crank shaft pulley 13 and the water pump pulley 14 are formed of, e.g., pressed metal, cast metal, or molded resin such as nylon resin and phenol resin. The diameter of the crank shaft pulley 13 is, e.g., φ120-170 mm, and the diameter of the water pump pulley 14 is, e.g., φ80-120 mm.

In the accessory drive belt transmission system 10 of the present embodiment, when the rotational speed of the engine 11 is equal to or higher than 4000 rpm, the rotational fluctuation ratio of the crank shaft pulley 13 at an outer circumferential surface thereof may sometimes be equal to or greater than 6%. In such a case, the rotational fluctuation ratio is sometimes equal to or greater than 8%. The “rotational fluctuation ratio” means a value obtained by dividing a difference between a maximum value peak for rotational speed and a minimum value peak for rotational speed by an average rotational speed.

Moreover, in the accessory drive belt transmission system 10 of the present embodiment, a span length between the crank shaft pulley 13 and the water pump pulley 14 is equal to or longer than 220 mm. That is, in the layout in which the V-ribbed belt 20 is wound on the crank shaft pulley 13 and the water pump pulley 14, at least one of span lengths is equal to or longer than 220 mm. The span length may be equal to or longer than 240 mm, or may be up to 350 mm. The “span length” means a distance between contact points of a common tangent with a pair of pulleys which are arranged adjacent to each other and on which a V-ribbed belt is wound (see “Practical Designing for Belt Transmission: Belt Transmission Technology Forum,” Page 56, Yokendo Publishing).

Further, in the accessory drive belt transmission system 10 of the present embodiment, tension loaded to the V-ribbed belt 20 wound on the crank shaft pulley 13 and the water pump pulley 14 is, e.g., 15-70 N per V-shaped rib.

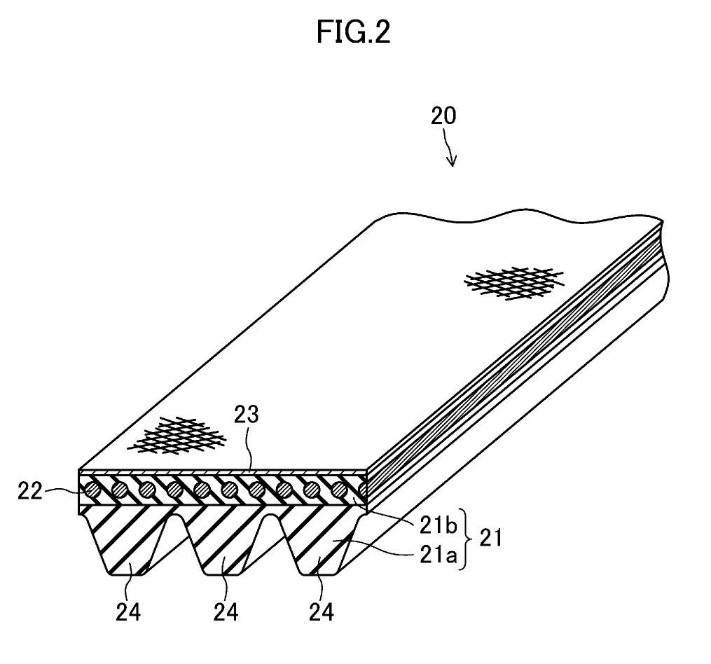

FIG. 2 illustrates the V-ribbed belt 20. The V-ribbed belt 20 has, e.g., a length of 800-1200 mm, a width of 10-15 mm, and a thickness of 4.0-5.0 mm.

The V-ribbed belt 20 includes a V-ribbed belt body 21 made of rubber and having a double layer structure of a compressed rubber layer 21a which serves as a pulley contact part of the V-ribbed belt 20 at the inner circumference thereof and an adhesive rubber layer 21b which is formed on an outer circumferential side relative to the compressed rubber layer 21a. In the adhesive rubber layer 21b, a core wire 22 to which adhesion treatment is applied is embedded. Moreover, a back reinforcement fabric 23 to which adhesion treatment is applied is bonded to an outer circumferential part of the adhesive rubber layer 21b.

In the compressed rubber layer 21a, three or four V-shaped ribs 24 (three V-shaped ribs 24 in FIG. 2) are formed on an inner circumferential side of the V-ribbed belt 20 so as to extend downward. The V-shaped ribs 24 are each a protrusion extending in a belt length direction and having a substantially inverted triangular cross section, and are arranged in parallel to each other in a belt width direction. The height of each V-shaped rib 24 is, e.g., 2.0-3.0 mm, and the width of each V-shaped rib 24 at a base end thereof is, e.g., 1.0-3.6 mm.

The adhesive rubber layer 21b is formed in a strip shape having a horizontally-elongated rectangular cross section, and has a thickness of, e.g., 1.0-2.5 mm.

The compressed rubber layer 21a and the adhesive rubber layer 21b are made of a rubber composition obtained in such a manner that an uncrosslinked rubber composition obtained by mixing a rubber component with various compounding agents is heated, pressurized, and crosslinked with a crosslinking agent. Such a rubber composition may be formed using sulfur as the crosslinking agent, or may be formed using organic peroxide as the crosslinking agent. The compressed rubber layer 21a and the adhesive rubber layer 21b may be made of rubber compositions different from each other in formulation, or may be made of rubber compositions identical to each other in formulation.

Examples of the rubber component of the rubber composition forming the compressed rubber layer 21a and the adhesive rubber layer 21b include ethylene-cc-olefin elastomer (EPDM, EPR, etc.), chloroprene rubber (CR), chlorosulfonated polyethylene rubber (CSM), and hydrogenated acrylonitrile rubber (H-NBR). Examples of the compounding agents include a reinforcer, a filler, an antioxidant, a softener, a crosslinking agent, and a vulcanization accelerator.

The rubber composition forming the compressed rubber layer 21a may be mixed with short fibers such as nylon short fibers. In such a case, it is preferred that the short fibers are aligned in the belt width direction in the compressed rubber layer 21a and protrude from a surface of the compressed rubber layer 21a. Note that the short fibers may not be mixed with the rubber composition forming the compressed rubber layer 21a, but may adhere to the surface of the compressed rubber layer 21a.

The core wire 22 is arranged so as to form a helical pattern with a pitch in the belt width direction, and the pitch between adjacent turns of the helical pattern is, e.g., 0.8-1.5 mm. Note that, in the case where a single S-twisted core wire and a single Z-twisted core wire are wound together, the pitch is twice as long as the foregoing pitch.

The core wire 22 is formed of aliphatic polyamide fibers (PA). Examples of the aliphatic polyamide fibers include nylon 66 fibers, nylon 6 fibers, nylon 46 fibers, nylon 610 fibers, nylon 12 fibers, nylon 611 fibers, and nylon 612 fibers.

The fineness of a filament yarn of the aliphatic polyamide fibers forming the core wire 22 is, e.g., 2-6 dtex, and a filament diameter is, e.g., 14-25 μm. The total fineness of the aliphatic polyamide fibers forming the core wire 22 is, e.g., 2500-10000 dtex. The outer diameter of the core wire 22 is, e.g., 0.5-1.5 mm

Examples of the yarns of the core wire 22 include single twisted yarns, plied yarns, Lang lay yarns, and braids. Among these yarns, the single twisted yarns or the plied yarns are preferable.

In the case where the core wire 22 is formed of single twisted yarns, the number of twists of the single twisted yarn is, e.g., 3-20 twists every 10 cm. The single twisted yarns of the core wire 22 may be S-twisted yarns or Z-twisted yarns. Alternatively, the single twisted yarns of the core wire 22 may be formed such that both of S-twisted yarns and Z-twisted yarns are used to form a double helical pattern.

In the case where the core wire 22 is formed of plied yarns, the fineness of a first twisted yarn is, e.g., 100-1000 dtex. The number of twists of the first twisted yarn is, e.g., 6-35 twists every 10 cm. The number of the first twisted yarns is, e.g., 2-7. The number of twists of a second twisted yarn is, e.g., 3-20 twists every 10 cm. The plied yarns of the core wire 22 may be S-twisted plied yarns formed such that the second twisted yarns are S-twisted yarns, or may be Z-twisted plied yarns formed such that the second twisted yarns are Z-twisted yarns. Alternatively, the plied yarns of the core wire 22 may be formed such that both of S-twisted yarns and Z-twisted yarns are used to form a double helical pattern.

Examples of the adhesion treatment applied to the core wire 22 include treatment for dipping the core wire 22 in an RFL water solution and heating the core wire 22. Before the treatment using the RFL water solution, the core wire 22 may be dipped in a primer solution formed by dissolving epoxy or isocyanate (blocked isocyanate) in, e.g., a solvent of toluene or dispersing epoxy or isocyanate in water, and then may be heated. Alternatively, after the treatment using the RFL water solution, the core wire 22 may be dipped in rubber cement formed by dissolving an unvulcanized rubber composition in, e.g., a solvent of toluene, and then may be dried.

The back reinforcement fabric 23 is provided so as to cover a back surface of the belt 20, and has a thickness of, e.g., 0.6-1.0 mm.

Example of fibers forming the back reinforcement fabric 23 include cotton, polyamide fibers, polyester fibers, and aramid fibers. The back reinforcement fabric 23 may be formed of a single type of fibers or plural types of fibers. The fineness of a filament yarn of the fibers forming the back reinforcement fabric 23 is, e.g., 2-6 dtex, and a filament diameter is, e.g., 14-25 μm.

Examples of the back reinforcement fabric 23 include woven fabrics, knitted fabrics, and non-woven fabrics. Among these fabrics, the woven fabrics are preferable. Examples of the woven fabric include plain fabrics, twill woven fabrics, sateen weave fabrics, and ribbed fabrics.

In the case where the back reinforcement fabric 23 is a woven fabric, the fineness of a warp yarn or a weft yarn is, e.g., 250-400 dtex. It is preferred that an angle between the direction in which the warp yarn of the back reinforcement woven fabric 23 extends and the direction in which the weft yarn of the back reinforcement woven fabric 23 extends is equal to or greater than 100°, and that a wide angle faces in the belt length direction. In such a case, it is preferred that an angle between the direction in which the warp yarn extends and the belt length direction is identical to an angle between the direction in which weft yarn extends and the belt length direction, and that an angle between the direction in which the warp yarn extends and the belt width direction is identical to an angle between the direction in which weft yarn extends and the belt width direction.

Examples of the adhesion treatment applied to the back reinforcement fabric 23 include treatment for dipping the back reinforcement fabric 23 in an RFL water solution and heating the back reinforcement fabric 23. Before the treatment using the RFL water solution, the back reinforcement fabric 23 may be dipped in a primer solution formed by dissolving epoxy or isocyanate (blocked isocyanate) in, e.g., a solvent of toluene or dispersing epoxy or isocyanate in water, and then may be heated. Alternatively, after the treatment using the RFL water solution, the back reinforcement fabric 23 may be dipped in rubber cement formed by dissolving an unvulcanized rubber composition in, e.g., a solvent of toluene, and then may be dried. As another alternative, a surface of the back reinforcement fabric 23 close to the V-ribbed belt body 21 may be, after the treatment using the RFL water solution, coated by rubber cement formed by dissolving an unvulcanized rubber composition in, e.g., a solvent of toluene, and then may be dried.

Note that the V-ribbed belt 20 may be manufactured in a publicly-known method.

For the purpose of fuel efficiency improvement, attempts have been made to, e.g., reduce the weight of an engine of an automobile and reduce friction in the engine of the automobile. However, the rotational fluctuation ratio of a crank shaft pulley at an outer circumferential surface thereof is equal to or less than 3% at a rotational speed of equal to or higher than 4000 rpm in a conventional engine, whereas the rotational fluctuation ratio of a crank shaft pulley at an outer circumferential surface thereof is sometimes equal to or greater than 6% at a rotational speed of 4000 rpm in an engine for which the foregoing improvement was made. In the layout in which a V-ribbed belt is wound such that at least one of the span lengths is equal to or longer than 220 mm, there is another disadvantage that the V-ribbed belt including a core wire formed of aliphatic polyamide fibers violently vibrates due to a high rotational fluctuation ratio upon high-speed rotation, and then is displaced over a pulley.

Suppose that the rotational fluctuation ratio of the crank shaft pulley 13 at the outer circumferential surface thereof is sometimes equal to or greater than 6% when the rotational speed of the engine 11 is equal to or higher than 4000 rpm, and at least one of the span lengths is equal to or longer than 220 mm in the layout in which the V-ribbed belt 20 is wound on the crank shaft pulley 13 and the water pump pulley 14. According to the accessory drive belt transmission system 10 of the present embodiment as described above, since the back reinforcement fabric 23 is provided in the V-ribbed belt 20, the V-ribbed belt 20 can be prevented from being displaced over the crank shaft pulley 13 or the water pump pulley 14 even in the foregoing state.

In the present embodiment, the layout is designed such that the V-ribbed belt 20 is wound on two pulleys, i.e., the crank shaft pulley 13 and the water pump pulley 14, but the present disclosure is not limited to such a configuration. The layout may be designed such that the V-ribbed belt 20 is wound on three or more pulleys.

### EXAMPLE

### V-Ribbed Belt

### Example

A PK V-ribbed belt according to the standard of JASO-E109 was manufactured using a core wire (fineness of 940 dtex/2×3 plied yarns) formed of nylon 66 fibers (“Leona” manufactured by Asahi Kasei Corporation) and a back reinforcement fabric (a ribbed fabric formed such that the fineness of a warp yarn or a weft yarn is 295 dtex, a wide angle between the direction in which the warp yarn extends and the direction in which the weft yarn extends is 120°, and a wide angle between the direction in which the warp yarn or the weft yarn extends and a belt width direction is 150°) formed of a mixture of polyester fibers (“T371” manufactured by Toray Industries, Inc.) and cotton. Such a V-ribbed belt was used as an example.

The V-ribbed belt of the example has a length of 856 mm and a thickness of 4.3 mm. The number of ribs is three, and the width of the belt is 10 mm. Note that a compressed rubber layer is made of an EPDM composition containing short fibers, and an adhesive rubber layer is made of an EPDM composition containing no short fibers.

### Comparative Example

The same V-ribbed belt as that of the example is manufactured, except that a back rubber layer made of the same EPDM composition as that of the adhesive rubber layer is provided instead of the back reinforcement fabric. Such a V-ribbed belt was used as a comparative example.

(Test and Evaluation Methods)

<Twist Angle Test>

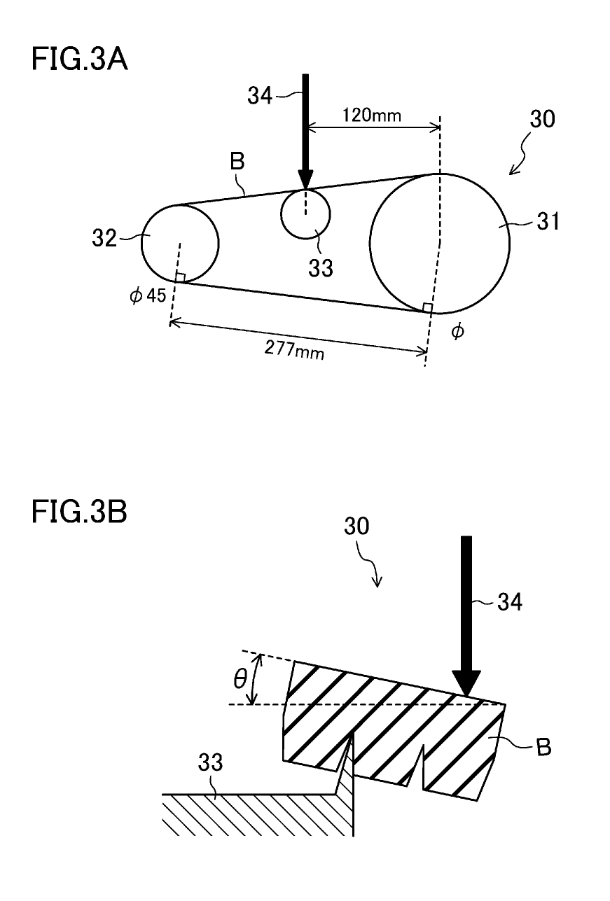

FIGS. 3A and 3B illustrate a twist angle test machine 30.

The twist angle test machine 30 includes a large ribbed pulley 31 having a diameter of 143 mm and a small ribbed pulley 32 having a diameter of 45 mm. A V-ribbed belt B is wound on the large ribbed pulley 31 and the small ribbed pulley 32. A span length is 277 mm. A support member 33 configured to support the V-ribbed belt B at a valley between adjacent ones of V-shaped ribs on a back side in a width direction of the V-ribbed belt B is provided between the large ribbed pulley 31 and the small ribbed pulley 32.

In each of the example and the comparative example, the V-ribbed belt B was wound on the large ribbed pulley 31 and the small ribbed pulley 32 of the twist angle test machine 30 such that tension of 30 N is loaded to the V-ribbed belt B. Then, in part of the V-ribbed belt B supported by the support member 33 at a position 120 mm apart from the center of the large ribbed pulley 31 in the horizontal direction, an end of the V-ribbed belt B on a front side in the width direction of the V-ribbed belt B was, without running the V-ribbed belt B, downwardly pressed by a press member 34 connected to a load cell. In such a state, a relationship between a pressing load F from the press member 34 and an angle θ between a back surface of the V-ribbed belt B and the horizontal direction, i.e., a twist angle θ of the V-ribbed belt B, was evaluated.

<Belt Running Test>

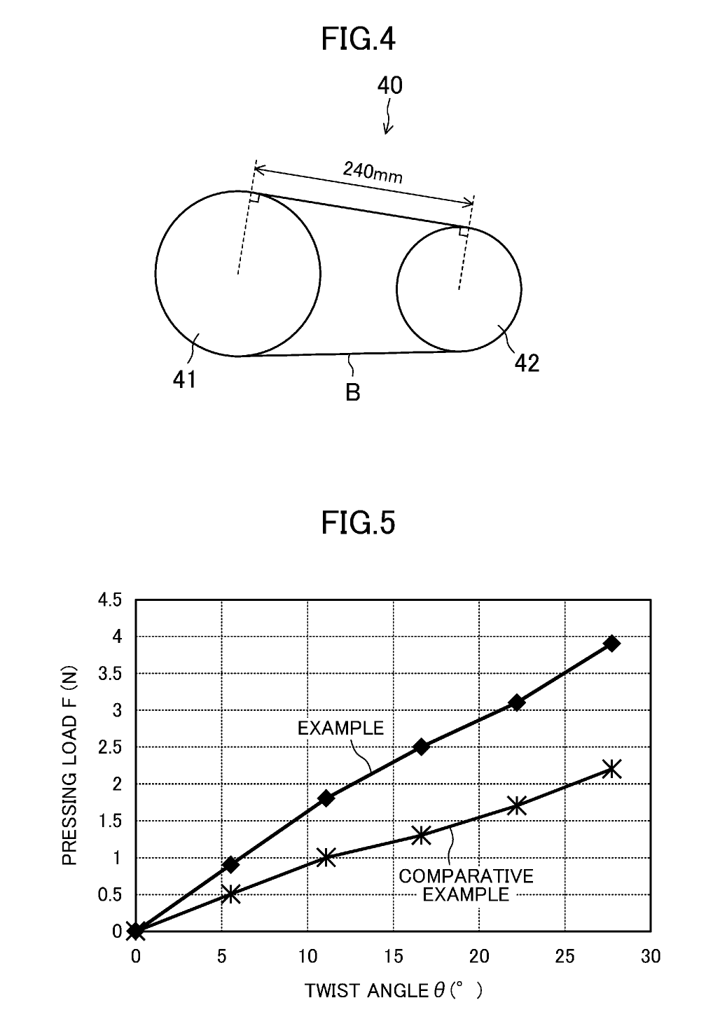

FIG. 4 illustrates a belt running test machine 40.

The belt running test machine 40 includes a drive pulley 41 which is a ribbed pulley having a diameter of 143 mm and a driven pulley 42 which is a ribbed pulley having a diameter of 100 mm. A V-ribbed belt B is wound on the drive pulley 41 and the driven pulley 42. A span length is 220 mm.

In each of the example and the comparative example, the V-ribbed belt B was wound on the drive pulley 41 and the driven pulley 42 of the belt running test machine 40 such that tension of 50 N is loaded to the V-ribbed belt B. Then, the drive pulley 41 was rotated at a rotational speed of 4000 rpm, and rotational fluctuation was caused such that a rotational fluctuation ratio of the drive pulley 41 at an outer circumferential surface thereof is 6%.

(Test and Evaluation Results)

FIG. 5 illustrates the relationship between the pressing load F from the press member 34 and the twist angle θ of the V-ribbed belt B.

According to FIG. 5, as compared to the comparative example where the back rubber layer is provided, a higher load is required for twist deformation in the example where the back reinforcement fabric is provided. Thus, in the example where the back reinforcement fabric is provided, the V-ribbed belt B is less likely to be twisted.

During the belt running test, the V-ribbed belt B in the example where the back reinforcement fabric is provided was stably running without displacement of the V-ribbed belt B over the pulley. On the other hand, in the comparative example where the back rubber layer is provided, the V-ribbed belt B was displaced over the driven pulley 42 during running.

The embodiment has been described above as an example technique of the present disclosure, in which the attached drawings and the detailed description are provided.

As such, elements illustrated in the attached drawings or the detailed description may include not only essential elements for solving the problem, but also non-essential elements for solving the problem in order to illustrate such techniques. Thus, the mere fact that those non-essential elements are shown in the attached drawings or the detailed description should not be interpreted as requiring that such elements be essential.

Since the embodiment described above is intended to illustrate the technique in the present disclosure, it is intended by the following claims to claim any and all modifications, substitutions, additions, and omissions that fall within the proper scope of the claims appropriately interpreted in accordance with the doctrine of equivalents and other applicable judicial doctrines.

What is claimed is:

1. An accessory drive belt transmission system for an automobile, comprising:
an engine;
a crank shaft pulley which is a ribbed pulley provided on a crank shaft of the engine;
an accessory drive pulley which is a ribbed pulley; and
a V-ribbed belt wound on a plurality of pulleys including the crank shaft pulley and the accessory drive pulley and having three or four V-shaped ribs,
wherein a rotational fluctuation ratio of the crank shaft pulley at an outer circumferential surface thereof is sometimes equal to or greater than 6% at an engine rotational speed of equal to or higher than 4000 rpm, and at least one of span lengths is equal to or longer than 220 mm in a layout in which the V-ribbed belt is wound on the plurality of pulleys, and
the V-ribbed belt includes
a V-ribbed belt body made of rubber and formed with the V-shaped ribs on an inner circumferential side thereof,
a core wire embedded in the V-ribbed belt body and formed of aliphatic polyamide fibers, and
a back reinforcement fabric bonded to an outer circumferential part of the V-ribbed belt body.

2. The accessory drive belt transmission system of claim 1, wherein
the plurality of pulleys only include the crank shaft pulley and the accessory drive pulley.

3. The accessory drive belt transmission system of claim 2, wherein
the accessory drive pulley is a water pump pulley.

4. The accessory drive belt transmission system of claim 3, wherein
a diameter of the crank shaft pulley is φ120-170 mm, and a diameter of the water pump pulley is φ80-120 mm.

5. The accessory drive belt transmission system of claim 3, wherein
tension loaded to the V-ribbed belt wound on the crank shaft pulley and the water pump pulley is 15-70 N per V-shaped rib.

6. The accessory drive belt transmission system of claim 1, wherein
when the engine rotational speed is equal to or higher than 4000 rpm, the rotational fluctuation ratio of the crank shaft pulley at the outer circumferential surface thereof is sometimes equal to or greater than 8%.

7. The accessory drive belt transmission system of claim 1, wherein
at least one of the span lengths is 240-350 mm in the layout in which the V-ribbed belt is wound on the plurality of pulleys.

8. The accessory drive belt transmission system of claim 1, wherein
the V-ribbed belt is a PK V-ribbed belt formed according to a standard of JASO-E109.

9. A V-ribbed belt used for an accessory drive belt transmission system for an automobile including
an engine,
a crank shaft pulley which is a ribbed pulley provided on a crank shaft of the engine,
an accessory drive pulley which is a ribbed pulley, and
the V-ribbed belt wound on a plurality of pulleys including the crank shaft pulley and the accessory drive pulley and having three or four V-shaped ribs,
in which a rotational fluctuation ratio of the crank shaft pulley at an outer circumferential surface thereof is sometimes equal to or greater than 6% at an engine rotational speed of equal to or higher than 4000 rpm, and at least one of span lengths is equal to or longer than 220 mm in a layout in which the V-ribbed belt is wound on the plurality of pulleys, the V-ribbed belt comprising:
a V-ribbed belt body made of rubber and formed with the V-shaped ribs on an inner circumferential side thereof;
a core wire embedded in the V-ribbed belt body and formed of aliphatic polyamide fibers; and
a back reinforcement fabric bonded to an outer circumferential part of the V-ribbed belt body.

10. The V-ribbed belt of claim 9, wherein
the V-ribbed belt is a PK V-ribbed belt formed according to a standard of JASO-E109.
